(19) United States
(12) Patent Application Publication
(10) Pub. No.: US 2007/0157791 A1
(43) Pub. Date: Jul. 12, 2007

(54) Methods for infusing matter with vibration

(76) Inventor: Kenneth Mazursky, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/643,051

(22) Filed: Dec. 21, 2006

Related U.S. Application Data
(60) Provisional application No. 60/752,504, filed on Dec. 21, 2005.

(51) Int. Cl. G10D 3/04

(52) U.S. Cl. 84/298

(57) ABSTRACT

Methods of infusing matter with vibration. One method can include cleansing the matter with at least one vibration instrument and infusing the matter with vibration with at least one vibration instrument. The method can also include creating a buffer in the matter to retain the infused vibration in the matter for predetermined time.

### RELATED APPLICATIONS

The present patent application claims priority to U.S. Provisional Patent Application Ser. No. 60/752,504 filed on Dec. 21, 2005, the entire contents of which is herein incorporated by reference.

### BACKGROUND OF THE INVENTION

The sound of “Om” is believed by the Hindus and Buddhists to be the vibration by which creation was set in motion. The Om vibration is also the resonant tone and frequency of the Earth and has been used medicinally by East Asian cultures for thousands of years. Scientifically, the sound of Om (e.g., “Om vibrations”) registers at 136.10 Hz at 432.10 Hz, which is the same frequency as the Earth as it rotates around the Sun.

For decades, scientists from around the world, such as Viktor Schauberger, William Baumgartner, Johann Grander, Dr. Lee Lorenzen, Dick Wullert, and Japanese Scientist Dr. Masaru Emoto have published numerous studies and books on the effects of vibrations on water. Dr. Emoto has shown that water can be imprinted by vibrations, which alters the crystalline structure of water. For example, infusing water with certain “positive” types of vibrations creates a crystalline structure that includes fully-formed hexagonal crystals, and infusing water with certain “negative” vibrations creates a crystalline structure that includes asymmetrical crystals.

Humans vibrate at a scientifically measurable frequency. Humans and/or parts of humans vibrate at a “healthy” frequency when well and at a different, “less healthy” frequency when under stress, injury, and/or illness. Sound therapy is a treatment that utilizes sounds and other vibrations (e.g., Om vibrations) produced by ancient Himalayan bowls, Earth gongs, tuning forks, and/or other vibration instruments in order to reduce or eliminate stress, emotional, and/or physical pain. Sound therapy uses sound to generally reduce or recalibrate “less healthy” frequency and return a “healthy” frequency to an individual. Sound therapy has reportedly been used to treat a myriad of health issues, such as insomnia, vertigo, muscular pain, infertility, and even some forms of malignant tumors (e.g., as used at the Gaynor Institute of Oncology in New York).

The average human is 70% water. Water holds vibration at a 5-time greater magnitude than air (which is one reason why dolphins and whales can communicate across great distances), and water included in a human body infused with the vibrations, such as Om vibrations, can resonate to a cellular level of the body in order to help reduce or recalibrate less healthy frequencies and return the body to a harmonic or healthy frequency or resonance.

### SUMMARY OF THE INVENTION

Embodiments of the invention provide a method for infusing matter with vibration, such as the Om vibration. One method can include cleansing the matter with at least one vibration instrument and infusing the matter with vibration generated by at least one vibration instrument. The method can also include neutralizing unwanted vibrations with at least one vibration instrument. The vibration instruments can include Himalayan bowls and Earth gongs. The infused matter, such as potable water or other liquids, when used or consumed, is healthier than matter that has not been infused.

### BRIEF DESCRIPTION OF THE DRAWINGS

FIG. 1 schematically illustrates a process of infusing a liquid with vibration according to one embodiment of the invention.

FIGS. 2, 3, and 4 illustrate test results for a randomly chosen female volunteer.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

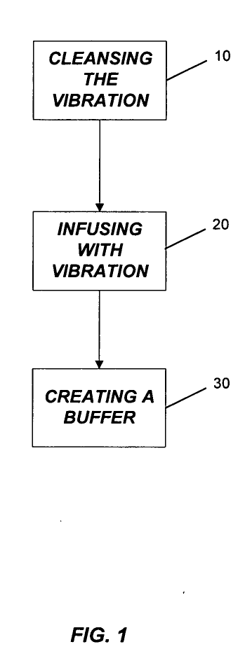

FIG. 1 schematically discloses an infusion process that infuses matter with vibration. In some embodiments, the infusion process, as disclosed in FIG. 1, can include an Om infusion process that infuses matter with Om vibration. In some aspects, term “matter” as used herein can refer to any solid, liquid, or mineral. Embodiments of the invention described herein, however, will be described with respect to liquids, such as water.

To set up the infusion process, a container of water is positioned adjacent to, across, or behind one or more vibration instruments. The container can include a plastic or glass container. The vibration instruments can include Himalayan bowls and/or Earth gongs, which, as described above, vibrate at approximately 136.10 Hz at 432.10 Hz. The vibration instruments can also include other musical instruments, such as gongs, tuning forks, drums, bowls (e.g., Buddhist “singing bowls.” Tibetan bowls, Bhutanese bowls, crystal bowls, etc.), cymbals, flutes, pianos, ghantas, dorjes, Tibetan cymbals (“ting-shaws”), etc. In some embodiments, the vibration instruments can also include voices (e.g., spoken word, singing, chanting). It should be understood that the vibration instruments can include “live” vibration instruments (e.g., instruments or voices) and/or vibration instruments with at least one speaker that broadcasts recorded sounds of “live” instruments.

As shown in FIG. 1, the process can involve three steps. A first step can include cleansing the pre-existing vibration of the water (step 10). Cleansing the pre-existing vibration of the water can include using various techniques to disorganize and eradicate any pre-existing vibrations in the water. For example, during the cleansing step, the vibration instruments can be used to apply vibrations of different speeds, directions, and/or magnitudes for a predetermined period of time (e.g., 10 or more minutes) to the water. The varying vibrations can cancel out pre-existing vibrations in the water so that few if any predominant vibrations exist in the water. In some embodiments, moving a vibration or sound clockwise with respect to the container of water can draw predominate vibrations away from the water. For example, gongs can be played in variations of geometric triads or other geometric shapes in order to cleanse the pre-existing vibrations in the water. Playing one or more vibration instruments in variations of geometric triads can include striking or initiating a vibration or sound with one or more vibration instruments at three positions of the vibration instruments, wherein the three positions are in a triangle formation relative to the container. For example, in one embodiment, water is cleansed by playing tings-shaws in a clockwise direction around the container for approximately 3 minutes. Next, Tibetan bowls are played in a clockwise direction around the container in various clusters of geometric triads for approximately 3 minutes. Then an Earth gong is played by striking the gong in various clusters of geometric triads in a clockwise direction around the container for approximately 5 minutes. Additionally, other therapy techniques from Buddhist and/or South and North American indigenous medicine cultures can be used to infuse the water with particular vibrations and/or to aid the cleansing process of the water.

A second step of the process includes infusing the water over a predetermined period of time (e.g., 10 or more minutes) with vibrations using various techniques to imprint vibration on the water (step 20). For example, during this step, the vibration instruments can apply the sound of Om to the water. Other therapy techniques from Buddhist and/or South and North American indigenous medicine cultures can also be used to infuse the water with particular vibrations. In some embodiments, the vibrations applied by the vibration instruments can begin as low tones and low volumes with long frequencies. Then, tones generated by the vibration instruments can build in momentum allowing the frequency, the volume, or the sound magnitude to increase in order to bring the vibration instruments to crest. Moving the sound counter-clockwise relative to the container of water infuses the water with vibration. For example, a vibration instrument, such as a gong, can be played in variations of geometric triads or other shapes similar to the manner mentioned above. In one embodiment, water is infused with vibration by playing an Earth Gong in various clusters of geometric triads in a counter-clockwise direction around the container while, simultaneously, playing Tibetan bowls in complementary clusters of geometric triads in a counter-clockwise direction around the container for approximately 15 minutes.

As shown in FIG. 1, a third step of the process can include creating a buffer in the water in order to increase and/or retain the infused vibrations in the water for a sustained and predetermined period of time (step 30). For example, vibration instruments having high frequency capabilities, such as ting-shaws, can be used to harmonize with the infused vibrations (e.g., with the Om vibrations and similar sounds) and protect or neutralize typical environmental frequencies that attempt to penetrate and disorganize (e.g., truck noise, fork lifts, etc.) the infused vibrations. For example, in one embodiment, ting-shaws can be played and moved around the container in a counter-clockwise direction for approximately 5 minutes in order to protect the infused vibrations. Other therapy techniques from Buddhist and/or South and North American indigenous medicine cultures can also be used to infuse the water with vibrations and to aid in protecting the infused vibrations. Optionally, other actions can also be taken in order to help retain the infused vibrations and/or the strength of the infused vibrations. For example, the water can be placed in a sound proof container or room.

In some embodiments, after the infusion process, the water can be tested or examined in order to determine the degree of vibration infused in the water. For example, samples of the water can be frozen before and after the infusion process in order to view and/or measure the altered crystalline structure of the water. The vibrations can also be felt by placing your hand near the energy field of the bottle or container containing the infused water. Additionally, the vibration can be measured using instruments, such as a magnetic resonance analyzer or an instrument that measures frequency (e.g., in hertz). The vibration's effects on a consumer of the infused water can also be measured using various instruments, such as a Limbic Stress Analyzer (“LSA”) manufactured by Zyto located in Orem, Utah as described below.

The frequency of the vibrations infused in the water can also be measured before and/or after the infusion process. In some embodiments, the infusion process, as described above, can be repeated one or more times in order to attempt to reinforce the effect of the infusion process. The infusion process can also be repeated in order to re-infuse or increase the strength of the previously-infused vibrations of the water, which may naturally dissipate after the infusion process.

After the infusion process, the infused water can be distributed into one or more containers (e.g., water bottles) and/or combined with other types of matter for human or animal use or consumption. Alternatively, the infusion process can take place with the water already in a container that will be used to deliver the infused water to a consumer.

As noted above, the vibration's effects on a consumer of the infused water can be measured using a LSA. The LSA is an assessment tool that tracks the body's stress system, which includes approximately 30 different organs, glands, and systems. The body is made up of various systems that can respond to stimuli. For example, the smell of food (stimulus) can trigger the mouth to salivate (response) and a loud noise (stimulus) can trigger the release of adrenaline into the blood and an increase heart rate (response). Physical stress is your body's reaction to any stimulus or stressor in an attempt to maintain balance. Stressors can be environmental, emotional, or physical. For example, fatigue from staying up too late, emotional strain from a death in the family, and a flu virus are all stressors.

The body's systems are designed to operate with high energy, good health, and general homeostasis (balance). Stressors threaten to upset optimal balance because a body has limited resources to react to stressors. For example, while a health, balanced body generally has the capacity to deal with most stressors, an overtaxed or overstressed body can eventually experience difficulty in pushing back or reacting to stressors, which can lead to fatigue, pain, weight gain, and susceptibility to illness.

There are various ways to measure the body's response to stimuli. One way includes measuring a Galvanic Skin Response (“GSR”) of a body. When a body encounters a stressor and “stresses back,” the ability of a body's skin, the body's largest organ, to conduct minute electrical impulses varies. This change in conductivity is called galvanic skin response or GSR.

The conductivity of the skin was first discovered around 1888 by Tarchanoff. In the early 1900s, Dr. Carl Jung established that GSR measurements could track physiological arousal or stress in the body, and in the 1930s, Dr. Hans Selye began to uncover the importance of understanding stress and what information it could tell us about the different systems of the body. These discoveries of the importance of stress in the body and its ability to be measured through GSR measurements have led to the creation of many common devices, such as the polygraph test.

Late in the 20^{th} century, many researchers identified further uses for GSR test, such as recognizing that GSR could be monitored on acupuncture points to measure the body's energy meridians and recognizing that GSR measurements could be used to track the body's energetic state and balance. In the late 1990s, integrating Eastern Medicine with Western research in stress and GSR, Dr. Vaughn R. Cook began research to advance the theory of the body's internal “stress system” that is related to and interacts with all other systems of the body. A balanced stress system brings about optimal quality of life, whereas, an imbalanced system leads to problems that may show up as fatigue, weight gain, low energy, chronic pain, etc.

The LSA was developed to measure the body's stress system. Similar to a polygraph technician asking a subject questions and evaluating the body's response, the LSA uses GSR to measure the stress system's response to virtual stimuli in approximately real-time. Generally, the LSA “asks” the body questions and measures how the body responds. The LSA asks the body questions by applying its library of computer-generated virtual stressors or signals to the body. The signals are associated with over 30,000 assessable items. The LSA emits the chosen signals, then records and analyzes the body's reaction to them. Groups of items can be selected by an operator for assessment. Each item tested takes one second.

The responses from the body are used to create a “stress profile,” which reveals the state of balance and imbalance within the stress system of the body. Along with various graphical representations of the results, software included in the LSA displays the body's reaction to each stressor or signal as a negative number (which indicates a stress response) or a positive number (which indicates a balance response) called a deviation ratio (“dR”); the larger the deviation ratio, the more significant the response.

Next, the LSA “queries” the body with possible balancing solutions and measures the response to the possible solutions in order to determine the best approaches for increasing the state of balance within the stress system of the body. Through implementation of the determined best approaches, the stress system can become more balanced, which leads to improved quality of life for the individual.

Matter infused with vibration, as described in the present application, when used or consumed, has been tested. For example, water infused with Om vibrations has been tested using a LSA. Tests were conducted using volunteers who were selected at random. As a first step of the tests, the LSA was used to take an initial stress profile of each of the volunteers. Next, volunteers were given a bottle of water infused with Om and were asked to drink approximately 2 or 3 ounces. After each volunteer consumed the directed amount of infused matter, the LSA was used to take another reading and to create a second stress profile.

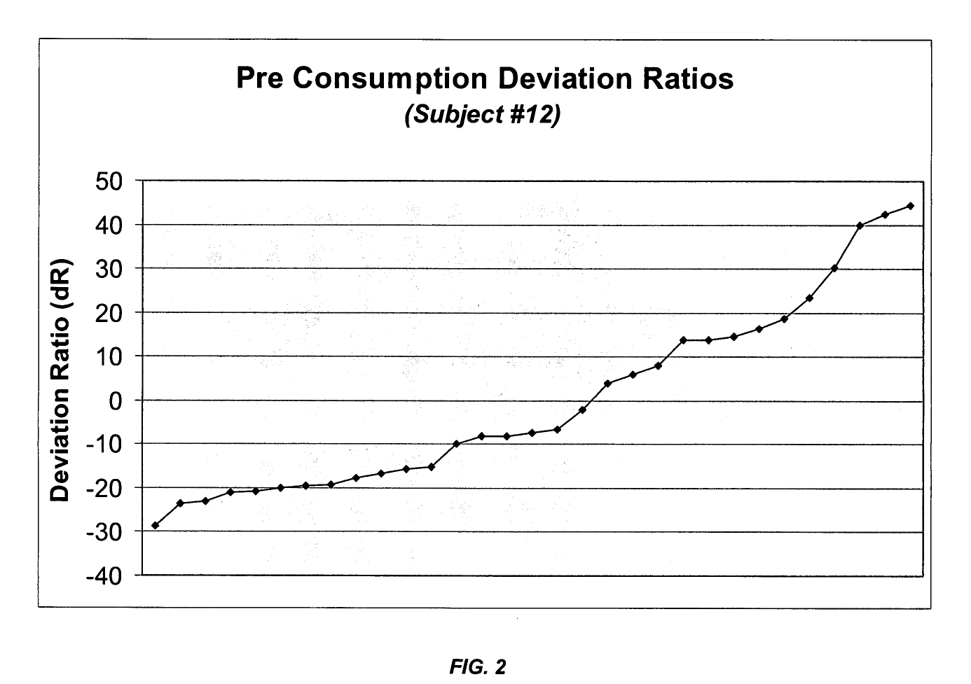

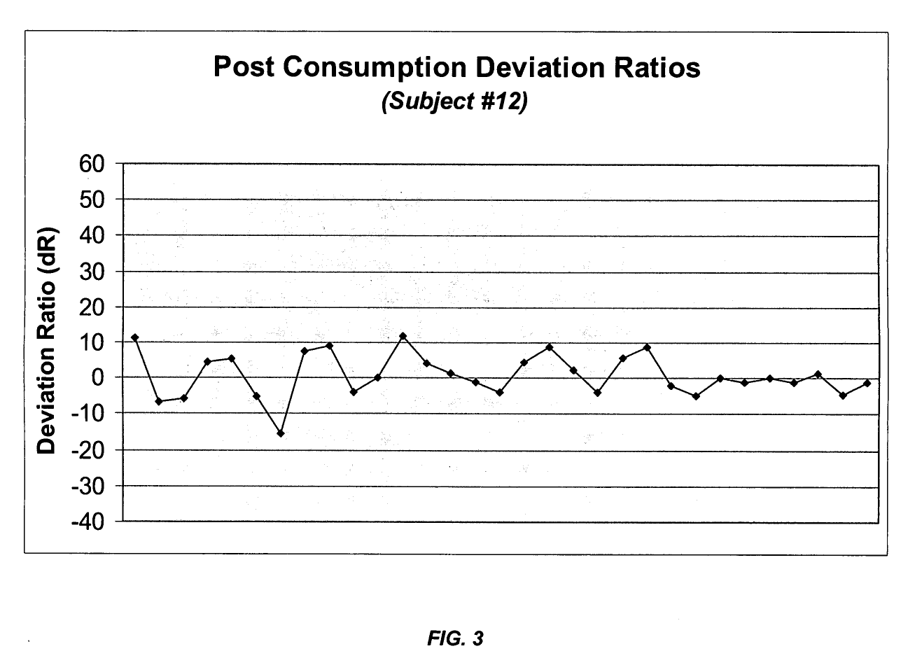

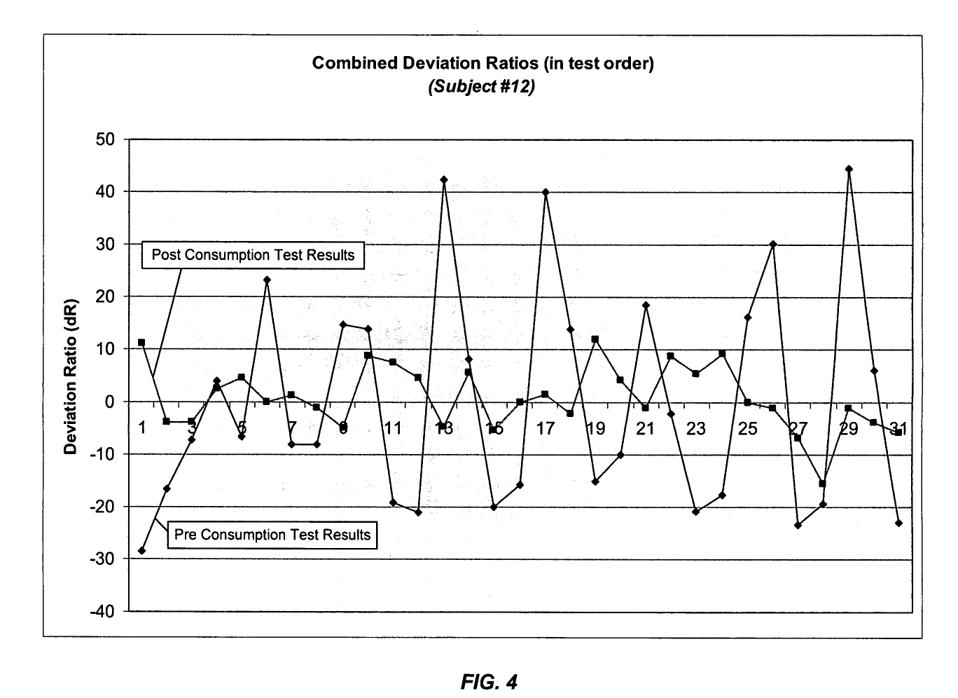

When comparing the initial stress profile to the second stress profile for each volunteer, the consumption of water infused with Om vibrations appeared to balance and/or counteract the stress levels in at least 24 of the 30 organs, glands, and systems included in a body's stress system. In fact, in many tests, the consumption of water infused with Om vibrations appeared to balance or counteract the stress levels of all 30 organs, glands, and systems included in a body's stress system. Furthermore, consumption of the water infused with Om vibrations appeared to balance and/or counteract the stress levels of the highest stressed organs, glands, and systems of each volunteer approximately 98% of the time. Table 1, below, and FIGS. 2 and 3 illustrate test results for a randomly chosen female volunteer. FIG. 4 combines the pre-consumption test results and the post-consumption test results included in Table 1 and reorganizes the results based on the order in which the results were obtained during the test.

TABLE 1

| | Pre | Post | |
|---|---|---|---|
| Subject | Consumption | Consumption | |
| # | dR | dR | Organ |
| 12 | −28.57 | 11.11 | Adrenal Glands |
| 12 | −23.53 | −6.85 | Teeth/Jaw |
| 12 | −23.08 | −5.88 | Uterus |
| 12 | −21.05 | 4.48 | Large Intestine |
| 12 | −20.83 | 5.41 | Skin |
| 12 | −20 | −5.33 | Lymphatic System |
| 12 | −19.51 | −15.49 | Thymus |
| 12 | −19.15 | 7.46 | Kidney |
| 12 | −17.78 | 9.21 | Small Intestine |
| 12 | −16.67 | −3.85 | Arteries/Veins |
| 12 | −15.79 | 0 | Ovary |
| 12 | −15.22 | 11.94 | Peripheral Nervous System |
| 12 | −10 | 4.05 | Pineal Gland |
| 12 | −8.16 | 1.27 | Gallbladder |
| 12 | −8.16 | −1.2 | Heart |
| 12 | −7.32 | −3.9 | Bladder |
| 12 | −6.67 | 4.48 | Colon |
| 12 | −2.17 | 8.75 | Sinus |
| 12 | 3.92 | 2.38 | Central Nervous System |
| 12 | 6.12 | −3.85 | Urinary Tract |
| 12 | 8.16 | 5.56 | Lungs |
| 12 | 13.95 | 8.86 | Joints/Connective issue |
| 12 | 13.95 | −2.25 | Parathyroid Gland |
| 12 | 14.71 | −5 | Hypothalamus Gland |
| 12 | 16.28 | 0 | Spleen |
| 12 | 18.6 | −1.19 | Pituitary Gland |
| 12 | 23.33 | 0 | Eyes |
| 12 | 30.23 | −1.25 | Stomach |
| 12 | 40 | 1.3 | Pancreas |
| 12 | 42.42 | −4.71 | Liver |
| 12 | 44.44 | −1.15 | Thyroid |

It should be noted that the LSA has also been used to test the effects of consuming water not infused with vibrations, and the tests have generally not shown results similar to the results associated with consuming water infused with Om vibrations.

The above method can also be used to infuse two or more types of matter. For example, vitamins, minerals, and/or oils can be infused with another matter, such as drinkable liquids, cosmetics, lotions, shampoos, conditioners, liquid soaps, etc., using the vibrations provided by the vibration instruments.

It should be understood that above method can be performed manually, automatically, or a combination thereof. For example, a vibration instrument can be programmed to apply a particular vibration or particular vibrations over a predetermined amount of time in a predetermined manner.

Various features and advantages of the invention are set forth in the following claims.

What is claimed is:

1. A method of infusing matter with vibration comprising:
cleansing the matter with at least one vibration instrument; and
infusing the matter with vibration with at least one vibration instrument.

2. The method of claim 1, wherein the matter includes water.

3. The method of claim 1, wherein the matter includes at least one of lotion, juice, conditioner, shampoo, liquid soap, and oil.

4. The method of claim 1, wherein cleansing the matter with at least one vibration instrument includes cleansing the matter by applying vibrations generated with at least one vibration instrument to the matter for a predetermined period of time.

5. The method of claim 4, wherein cleansing the matter by applying vibrations generated with at least one vibration instrument to the matter for a predetermined period of time includes cleansing the matter by applying vibrations generated with at least one vibration instrument to the matter for at least approximately 10 minutes.

6. The method of claim 4, wherein cleansing the matter by applying vibrations generated with at least one vibration instrument to the matter for a predetermined period of time includes cleansing the matter by applying vibrations of different speeds generated with at least one vibration instrument to the matter.

7. The method of claim 4, wherein cleansing the matter by applying vibrations generated with at least one vibration instrument to the matter for a predetermined period of time includes cleansing the matter by applying vibrations of different directions generated with at least one vibration instrument to the matter.

8. The method of claim 4, wherein cleansing the matter by applying vibrations generated with at least one vibration instrument to the matter for a predetermined period of time includes cleansing the matter by applying vibrations of different magnitudes generated with at least one vibration instrument to the matter.

9. The method of claim 4, wherein cleansing the matter by applying vibrations generated with at least one vibration instrument to the matter for a predetermined period of time includes cleansing the matter by applying clockwise vibrations generated with at least one vibration instrument to the matter.

10. The method of claim 4, wherein cleansing the matter by applying vibrations generated with at least one vibration instrument to the matter for a predetermined period of time includes cleansing the matter by applying geometric triad vibrations with at least one vibration instrument to the matter.

11. The method of claim 1, wherein cleansing the matter with at least one vibration instrument includes cleansing the matter with at least one of a bowl, a gong, a drum, a tuning fork, a cymbal, a flute, a piano, ghantas, dorjes, and ting-shaws.

12. The method of claim 1, wherein cleansing the matter with at least vibration instrument includes cleansing the matter with at least one of a Himalayan bowl, a Buddhist singing bowl, a Tibetan bowl, a Bhutanese bowl, and a crystal bowl.

13. The method of claim 1, wherein cleansing the matter with at least one vibration instrument includes cleansing the matter with an Earth gong.

14. The method of claim 1, wherein cleansing the matter with at least one vibration instrument includes cleansing the matter with voices.

15. The method of claim 14, wherein cleansing the matter with voices includes cleansing the matter with at least one of spoken word, singing, and chanting.

16. The method of claim 14, wherein cleansing the matter with voices includes cleansing the matter with recorded voices.

17. The method of claim 14, wherein cleansing the matter with voices includes cleansing the matter with live voices.

18. The method of claim 1, wherein cleansing the matter with at least one vibration instrument includes playing ting-shaws in a clockwise direction around the matter for approximately 3 minutes, playing a Tibetan bowl in a plurality of geometric triads in a clockwise direction around the matter for approximately 3 minutes, and playing an Earth gong in a second plurality of geometric triads in a clockwise direction around the matter for approximately 5 minutes.

19. The method of claim 1, wherein infusing the matter with vibration with at least one vibration instrument includes infusing the matter with vibration by applying vibrations generated with at least one vibration instrument to the matter for a predetermined period of time.

20. The method of claim 19, wherein applying vibrations generated with at least one vibration instrument to the matter includes applying vibrations having a frequency of approximately 136.10 hertz at approximately 432.10 hertz generated with at least one vibration instrument to the matter.

21. The method of claim 19, wherein applying vibrations generated with at least one vibration instrument to the matter for a predetermined period of time includes applying vibrations generated with at least one vibration instrument to the matter for at least approximately 10 minutes.

22. The method of claim 19, wherein applying vibrations generated with at least one vibration instrument to the matter for a predetermined period of time includes applying counter-clockwise vibrations generated with at least one vibration instrument to the matter.

23. The method of claim 19, wherein applying vibrations generated with at least one vibration instrument to the matter for a predetermined period of time includes applying geometric triad vibrations with at least one vibration instrument to the matter.

24. The method of claim 1, wherein infusing the matter with vibration using at least one vibration instrument includes infusing the matter with at least one of a bowl, a gong, a drum, a tuning fork, a cymbal, a flute, a piano, ghantas, dorjes, and ting-shaws.

25. The method of claim 1, wherein infusing the matter with vibration using at least one vibration instrument includes infusing the matter with at least one of a Himalayan bowl, a Buddhist singing bowl, a Tibetan bowl, and a crystal bowl.

26. The method of claim 1, wherein infusing the matter with vibration using at least one vibration instrument includes infusing the matter with an Earth gong.

27. The method of claim 1, wherein infusing the matter with vibration using at least one vibration instrument includes infusing the matter with voices.

28. The method of claim 26 wherein infusing the matter with voices includes infusing the matter with at least one of spoken word, singing, and chanting.

29. The method of claim 26, wherein infusing the matter with voices includes infusing the matter with recorded voices.

30. The method of claim 26, wherein infusing the matter with voices includes infusing the matter with live voices.

31. The method of claim 1, wherein infusing the matter with vibration using at least one vibration instrument includes playing an Earth gong in a first plurality of geometric triads in a counter-clockwise direction around the matter while simultaneously playing Tibetan bowls in a second plurality of geometric triads in a counter-clockwise direction around the matter for approximately 15 minutes, the second plurality of geometric triads substantially complimentary to the first plurality of geometric triads.

32. The method of claim 1, further comprising creating a buffer in the matter to retain the infused vibration in the matter for predetermined time.

33. The method of claim 32, wherein creating a buffer in the matter to retain the infused vibration in the matter for a predetermined time includes creating a buffer in the matter by applying vibrations generated with at least one vibration instrument to the matter.

34. The method of claim 33, wherein creating a buffer in the matter by applying vibrations generated with at least one vibration instrument to the matter includes applying vibrations generated with a high frequency vibration instrument to the matter.

35. The method of claim 34, wherein applying vibrations generated with a high frequency vibration instrument to the matter includes applying vibrations generated with at least one of a cymbal or ting-shaws to the matter.

36. The method of claim 32, wherein creating a buffer in the matter to retain the infused vibration in the matter for predetermined time includes playing ting-shaws in a counter-clockwise direction around the matter for approximately 5 minutes.
